(19) United States
(12) Patent Application Publication
(10) Pub. No.: US 2004/0197246 A1
(43) Pub. Date: Oct. 7, 2004

(54) Fuel processing reactor with internal heat exchange for low pressure gas stream

(75) Inventors: James F. Stevens, Katy, TX (US); Curtis L. Krause, Houston, TX (US); Paul Francis Martin, Toronto (CA); Vijay Anant Deshpande, Houston, TX (US)

Correspondence Address: Chevron Texaco Corporation, 1111 Bagby, Suite 4040, Houston, TX, 77002, US

(73) Assignee: Texaco Inc., San Ramon, CA

(21) Appl. No.: 10/407,312

(22) Filed: Apr. 4, 2003

(51) Int. Cl. B01J 8/02

(52) U.S. Cl. 422/201; 422/211; 29/890.053

(57) ABSTRACT

A compact fuel processing reactor. The reactor includes a housing having an inlet for receiving a process gas and an outlet for a directing a product gas out of the housing. A catalyst bed that includes discrete particles of a refractory material is located within the housing for contacting the process gas. A coiled tubing heat exchanger is at least partially disposed within the catalyst bed for cooling the catalyst bed. The coiled tubing can comprise a smooth continuous outer surface in intimate contact with the discrete particles. The circulating cooling medium comprises water in liquid, gas or a mixture of liquid and gas phases. The discrete particles in the catalyst bed are in intimate contact with at least a portion of the coiled tubing to promote heat transfer from the catalyst bed to the coiled tubing. The heat exchanger has less than about 25, preferably less than about 20, more preferably less than about 15, and still more preferably less than about 10 square meters of heat exchanging surface area per cubic meter of catalyst bed. The catalyst bed can be a water gas shift, desulfurization or reforming bed. The reactor can include one or more additional catalyst beds arranged in series such that the housing enclosed a shift catalyst bed as well as a desulphurization bed and/or a reforming bed. Methods of cooling a catalyst bed within a compact reactor and methods of manufacturing a compact reactor are also provided.

### FIELD OF THE INVENTION

The present invention relates to fuel processing apparatus for converting hydrocarbon-based fuels into a hydrogen-enriched reformate for use by fuel cells or other devices requiring hydrogen-rich feed streams. More particularly, the present invention relates methods and apparatus includes having a shift converter or reactor for converting carbon monoxide and water to carbon dioxide and hydrogen.

### BACKGROUND OF THE INVENTION

Fuel cells provide electricity from chemical oxidation-reduction reactions and possess significant advantages over other forms of power generation in terms of cleanliness and efficiency. Typically, fuel cells employ hydrogen as the fuel and oxygen as the oxidizing agent. The power generation is proportional to the consumption rate of these reactants.

A significant disadvantage which inhibits the wider use of fuel cells is the lack of a widespread hydrogen infrastructure. Hydrogen has a relatively low volumetric energy density and is more difficult to store and transport than hydrocarbon fuels currently used in most power generation systems. One way to overcome this difficulty is the use of reformers to convert a hydrocarbon fuel to a hydrogen rich gas stream that can be used as a feed for fuel cells.

Hydrocarbon-based fuels, such as natural gas, LPG, gasoline, and diesel, require conversion processes to be used as fuel sources for most fuel cells. Current art uses multi-step processes combining an initial conversion process with several clean-up processes. The initial process is most often steam reforming (SR), autothermal reforming (ATR), catalytic partial oxidation (CPOX), or non-catalytic partial oxidation (POX) or combinations thereof. The resultant process gas or raw reformate contains hydrogen, carbon dioxide, and carbon monoxide. Clean-up processes for the reformate usually comprise a combination of desulphurization, high temperature water-gas shift, low temperature water-gas shift, selective CO oxidation, selective CO methanation or combinations thereof. Alternative processes for recovering a purified hydrogen-rich reformate include the use of hydrogen selective membrane reactors and filters.

Despite this work, there remains a need for methods and reactors that are capable of reliably and stably carrying out various reforming and/or clean-up reactions using low pressure reactants. More specifically, there is a need for a fuel processing reactor that can be used for a variety of fuel processing reactions without imposing a significant pressure drop on the reactants or process gas across the reactor.

### SUMMARY OF THE INVENTION

The present invention provides a compact fuel processing reactor. The reactor includes a housing having an inlet for receiving a process gas and an outlet for a directing a product gas out of the housing. A catalyst bed is disposed within the housing for contacting the process gas. The catalyst bed comprises discrete particles. A heat exchanger is at least partially disposed within the catalyst bed for cooling the catalyst bed and reacting gases.

The discrete particles in the catalyst bed are in intimate contact with at least a portion of the heat exchanger to promote the transfer of heat from the catalyst bed to the surface of the heat exchanger. The discrete particles preferably comprise a refractory material, and more specifically, the particles comprise alumina.

The heat exchanger includes coiled tubing having a stream of a cooling medium flowing or circulating through the coiled tubing. Preferably, the coiled tubing has a smooth continuous outer surface that is in intimate contact with discrete particles within the catalyst bed. The circulating cooling medium preferably comprises water in liquid, gas or a mixture of liquid and gas phases. The coiled tubing has less than about 25 square meters of heat exchanging surface area per cubic meter of catalyst bed. Preferably, the coiled tubing has less than about 20, more preferably less than about 15, and still more preferably less than about 10 square meters of heat exchanging surface area per cubic meter of catalyst bed.

The catalyst bed preferably comprises a shift catalyst, a pelletized zinc oxide or a partial oxidation catalyst. Optionally, the reactor can comprise one or more additional catalyst beds arranged in series within the housing. In such an embodiment, at least one of the catalyst beds comprises a high temperature shift catalyst and a second catalyst bed comprises a low temperature shift catalyst. Alternatively, at least one of the catalyst beds can comprise a desulphurization catalyst and a second catalyst bed comprises a low temperature shift catalyst. In a further alternative, at least one of the catalyst beds comprises a partial oxidation catalyst and a second catalyst bed comprises a shift catalyst.

In a process aspect of the present invention, a method for cooling a catalyst bed in a reactor is provided. The method comprises the step of contacting a catalyst bed within a reactor with a process gas to catalyze a reaction to produce a product gas. The catalyst bed includes discrete particles. The method further includes the step of passing a cooling medium through the catalyst bed within a coiled tubing heat exchanger. In addition, the method includes the step of exchanging heat between the catalyst bed and the coiled tubing during which the discrete particles provide thermal communication between the catalyst bed and coiled tubing. Further still, the process gas is at a first pressure and the product gas is at a second pressure and the difference between the first and second pressures is less than about 3 psi/ft, preferably less than about 2 psi/ft, more preferably less than about 1 psi/ft of reactor length. Preferably, the coiled tubing heat exchanger provides less than about 25 square meters of heat exchanging surface area per cubic meter of catalyst bed, more preferably less than about 20 m²/m³, still more preferably less than 15 m²/m³, and even still more preferably less than 10 m²/m³ of catalyst bed.

Preferably, the process gas comprises carbon monoxide and steam. Where the catalyst bed includes a shift catalyst, the inlet temperature of the process gas is above about 130° C. Where the catalyst bed comprises zinc oxide the inlet temperature of the process gas is at a temperature above about 400° C. Where the catalyst bed comprises a partial oxidation catalyst the outlet temperature of the process gas is between about 550° C. and about 900° C.

In a second process aspect, the present invention provides a method for manufacturing a shift reactor. The method comprises the steps of providing a housing having a process gas inlet and a product gas outlet, disposing a heat exchanger within the housing. The heat exchanger includes a length of coiled tubing having an inlet for receiving a stream of cooling medium, an outlet for directing a heated medium from the heat exchanger, and a smooth continuous outer surface. The method further includes obtaining a mixture of catalyst and discrete particles and disposing the mixture within the housing to form a catalyst bed. The coiled tubing provides less than about 25, preferably less than about 20, more preferably less than about 15, and still more preferably less than about 10 square meters of heat exchanging surface area per cubic meter of catalyst bed.

### BRIEF DESCRIPTION OF THE DRAWINGS

The invention may be understood by reference to the following description taken in conjunction with the accompanying drawings.

FIG. 1 is a schematic view of a reactor of the present invention comprising a single catalyst bed.

FIG. 2 is a schematic view of a reactor of the present invention comprising a plurality of catalyst beds.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE PREFERRED EMBODIMENTS

Illustrative embodiments of the invention are described below. In the interest of clarity, not all features of an actual embodiment are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover it will be appreciated that such a development effort might be complex and time-consuming, but would nevertheless be a routine undertaking for those of ordinary skill in the art having the benefit of this disclosure.

The present invention provides (1) a compact fuel processing reactor, (2) a method for cooling a catalyst bed in a compact reactor and (3) a method for manufacturing a compact shift reactor.

(1) A Compact Fuel Processing Reactor

Fuel Processing

Two different reactions are typically carried out in a fuel reforming process. Formulas I and II are exemplary reaction formulas wherein methane is considered as the hydrocarbon:

CH₄+½O₂=>2H₂+CO (I)

CH₄+H₂O=>3 H₂+CO (II)

The partial oxidation reaction (formula I) occurs very quickly to the complete conversion of oxygen added and is exothermic (i.e., produces heat). A higher concentration of oxygen in the feed stream favors the partial oxidation reaction. The steam reforming reaction (formula II), occurs slower and is endothermic (i.e., consumes heat). A higher concentration of water vapor favors steam reforming.

One of skill in the art should understand and appreciate that partial oxidation and steam reforming may be combined to convert pre-heated reformer reactants into a synthesis gas containing hydrogen and carbon monoxide. In such instances, the ratios of oxygen to hydrocarbon and water to hydrocarbon become characterizing parameters. These ratios affect the operating temperature and hydrogen yield. The operating temperature of the reforming step can range from about 550° C. to about 900° C., depending on the feed conditions and the catalyst.

The reformer uses a catalyst bed that may be in any form including pellets, spheres, extrudate, monoliths, and the like or wash coated onto the surface of fins or heat pipes. Partial oxidation catalysts should be well known to those with skill in the art and are often comprised of noble metals such as platinum, palladium, rhodium, and/or ruthenium on an alumina wash coat on a monolith, extrudate, pellet or other support. Non-noble metals such as nickel or cobalt have been used. Other wash coats such as titania, zirconia, silica, and magnesia have been cited in the literature. Many additional materials such as lanthanum, cerium, and potassium have been cited in the literature as “promoters” that improve the performance of the partial oxidation catalyst. Steam reforming catalysts should be known to those with skill in the art and can include nickel with amounts of cobalt or a noble metal such as platinum, palladium, rhodium, ruthenium, and/or iridium. The catalyst can be supported, for example, on magnesia, alumina, silica, zirconia, or magnesium aluminate, singly or in combination. Alternatively, the steam reforming catalyst can include nickel, preferably supported on magnesia, alumina, silica, zirconia, or magnesium aluminate, singly or in combination, promoted by an alkali metal such as potassium.

When the reforming process is primarily an autothermal reforming process, a cooling step is used to cool the reformate stream to a temperature of from about 600° C. to about 200° C., preferably from about 500° C. to about 300° C., and more preferably from about 425° C. to about 375° C., in preparation for various clean-up processes. This cooling may be achieved with heat sinks, heat pipes or heat exchangers depending upon the design specifications and the need to recover/recycle the heat content of the gas stream. More specifically, the reactors of the present invention can have one or more beds of inert material comprising discrete particles in place of a catalyst bed. In such an embodiment, a coiled tubing heat exchanger as is described in detail below is at least partially disposed within the bed for cooling the process gas passing through the bed.

Alternatively, or in addition thereto, cooling may be accomplished by injecting additional feed components such as fuel, air or water. Water is preferred because of its ability to absorb a large amount of heat as it is vaporized to steam. The amounts of added components depend upon the degree of cooling desired and are readily determined by those with skill in the art. When the reforming process is intended to be primarily a steam reforming process, cooling of the synthesis gas is optional because of the endothermic nature of the steam reforming process.

A common impurity in the raw reformate stream is sulfur, which is converted by the reforming process to hydrogen sulfide. The reformer reactor or a reactor downstream from the reformer can preferably include zinc oxide and/or other materials capable of absorbing and converting hydrogen sulfide, and may include a support (e.g., monolith, extrudate, pellet etc.). Desulphurization is accomplished by converting the hydrogen sulfide to water in accordance with the following reaction formula III:

H₂S+ZnO=>H₂O+ZnS (III)

Pelletized zinc oxide is preferred as it is an effective hydrogen sulfide absorbent over a wide range of temperatures from about 25° C. to about 700° C. and affords great flexibility for optimizing the sequence of processing steps by appropriate selection of operating temperature. In addition, as described below, desulfurization and cooling of the raw reformate stream can be carried out in a reactor of the present invention. Further, other impurities such as chlorides can also be removed in such a catalyst bed.

The purified reformate stream may then be sent to an optional mixing step in which water is added to the gas stream. The addition of water lowers the temperature of the reactant stream as it vaporizes and supplies more water for the water gas shift reaction. The water vapor and other reformate stream components can be mixed by being passed through a processing core of inert materials such as ceramic beads or other similar materials that effectively mix and/or assist in the vaporization of the water.

A typical water gas shift reaction converts carbon monoxide to carbon dioxide in accordance with formula IV:

H₂O+CO=>H₂+CO₂ (IV)

In this is reaction, carbon monoxide, a poison to fuel cells, is substantially removed from the gas stream and is converted into carbon dioxide, which is generally considered an inert gas in fuel cells. The concentration of carbon monoxide should preferably be lowered to a level that can be tolerated by fuel cells, typically below about 50 ppm. Generally, the water gas shift reaction can take place at temperatures of from 150° C. to 600° C. depending on the catalyst used. Under such conditions, most of the carbon monoxide in the gas stream is oxidized to carbon dioxide.

Low temperature shift catalysts operate at a range of from about 150° C. to about 300° C. and include for example, copper oxide, or copper supported on other transition metal oxides such as zirconia, zinc supported on transition metal oxides or refractory supports such as silica, alumina, zirconia, etc., or a noble metal such as platinum, rhenium, palladium, rhodium or gold on a suitable support such as silica, alumina, zirconia, and the like.

High temperature shift catalysts are preferably operated at temperatures ranging from about 300° to about 600° C. and can include transition metal oxides such as ferric oxide or chromic oxide, and optionally including a promoter such as copper or iron silicide. Other suitable high temperature shift catalysts are supported noble metals such as supported platinum, palladium and/or other platinum group members. The shift catalyst can also include a packed bed of high temperature or low temperature shift catalyst such as described above, or a combination of both high temperature and low temperature shift catalysts. Further still, shift catalyst beds of a first high temperature and a second low temperature shift catalyst can be arranged in series within a common reactor of the present invention that houses a plurality of catalyst beds, or alternatively disposed in separate individual reactors arranged in series. As described hereinafter, a heat exchanger is at least partially disposed within the shift catalyst bed of such a reactor to control the reaction temperature within the packed bed of catalyst as lower temperatures are favorable to the conversion of carbon monoxide to carbon dioxide.

In addition, selective oxidation can optionally be performed on the hydrogen-rich reformate to convert remaining carbon monoxide to carbon dioxide. Such reactions include: the desired oxidation of carbon monoxide (formula V) and the undesired oxidation of hydrogen (formula VI) as follows:

CO+½O₂=>CO₂ (V)

H₂+½O₂=>H₂O (VI)

The processing is carried out in the presence of a catalyst for the oxidation of carbon monoxide and may be in any suitable form, such as pellets, spheres, monolith, etc. Oxidation catalysts for carbon monoxide are known and typically include noble metals (e.g., platinum, palladium) and/or transition metals (e.g., iron, chromium, manganese), and/or compounds of noble or transition metals, particularly oxides. A preferred oxidation catalyst is platinum on an alumina wash coat. The wash coat may be applied to a monolith, extrudate, pellet or other support. Additional materials such as cerium or lanthanum may be added to improve performance. Many other formulations have been cited in the literature with some practitioners claiming superior performance from rhodium on alumina catalysts. Ruthenium, palladium, gold, and other materials have been cited in the literature as being active for this use as well. The preferential oxidation of carbon monoxide is favored by low temperatures. Because both reactions produce heat, a heat exchanger is at least partially disposed within the catalyst bed of such a reactor to remove heat generated in the process. The operating temperature of process is preferably kept in the range of from about 90° C. to about 150° C. Again, such an oxidation process can be utilized to reduce the carbon monoxide level to less than 50 ppm, a level that is suitable for use in fuel cells.

The hydrogen-rich reformate exiting the reforming reactor is a hydrogen rich gas containing carbon dioxide and other constituents such as water, inert components (e.g., nitrogen, argon), residual hydrocarbon, etc. This reformate can be used as the feed for a fuel cell or for other applications where a hydrogen-rich feed stream is desired. Optionally, the hydrogen-rich reformate may be sent on to further processing, for example, to remove carbon dioxide, water or other components.

Fuel reforming reactors are well known in the art. Such reformers include but are not limited to those described in U.S. patent application Publication Nos.: US 2002/0083646 A1 to Deshpande, et al., published Jul. 4, 2002; U.S. 2002/0090326 A1 to Deshpande, published Jul. 11, 2002; U.S. 2002/0090328 A1 to Deshpande, published Jul. 11, 2002; U.S. 2002/0090327 A1 to Deshpande, published Jul. 11, 2002; U.S. 2002/0088740 A1 to Krause, et al., published Jul. 11, 2002; U.S. 2002/0094310 A1, to Krause, et al., published Jul. 18, 2002; U.S. 2002/0155329 A1 to Stevens, published Oct. 24, 2002; U.S. 2003/00211741 A1 to Childress, et al., published Jan. 30, 2003; and U.S. 2003/0021742 to Krause, et al., published Jan. 30, 2003; the disclosure of each of which is incorporated herein by reference. When a reactor of the present invention is used for the reforming reaction is may be used in place of such known reformers. Alternatively, a reactor of the present invention may be used in combination with such known reformers when used for one or more of the downstream clean-up reactions, Fuel processors and reformers typically have an associated combustor that is either separate from or integrated with the reforming reactor and is used to heat reactants, generate steam, heat reactors, and dispose of undesirable by-products that are generated during the operation of the fuel processor and/or fuel cell. For instance, such combustors are frequently referred to as anode tail gas oxidizers since they are commonly used to combust tail gas from the anode of the fuel cell stack in addition to their role in the fuel processing operation. Suitable combustors include those disclosed in U.S. Pat. No. 6,077,620, issued Jun. 20, 2000 to Pettit (catalytic combustor fired by anode effluent and/or fuel from a liquid fuel supply that has been vaporized); U.S. Pat. No. 6,232,005, issued May 15, 2001 to Pettit (a tubular section at the combustor's input end intimately mixes the anode and cathode effluents before they contact the combustors primary catalyst bed; the tubular section comprises at least one porous bed of mixing media that provides a tortuous path for creating turbulent flow and intimate mixing of the anode and cathode effluents therein); and U.S. Pat. No. 6.342,197, issued Jan. 29, 2002 to Senetar, et al. (describing and comparing combustors with a variety of features and configurations), the disclosures of which are incorporated herein by reference. Other suitable combustors include those described in U.S. patent application Ser. No. ______ “Method and Apparatus for Rapid Heating of Fuel Reforming Reactants” to Nguyen, filed Apr. 4, 2003 (Attorney Docket No. X-0076), and in U.S. patent application Ser. No. ______ “Anode Tailgas Oxidizer” to Deshpande, et al., filed Apr. 4, 2003 (Attorney Docket No. X-0075), the disclosures of which are incorporated herein by reference.

Again, the compact fuel processing reactors of the present invention can be used to carry out one or more of the processes described above, including but not limited to the reforming reaction, desulfurization, high and/or low temperature shift reactions, selective oxidation reactions, intermediate cooling of associated process gases and various combinations thereof. In addition, the reactors of the present invention are intended to provide a means with which such fuel processing functions can be achieved within a minimal pressure loss on the subject process gases. The compact reactors of the present invention include a housing, a catalyst bed and a heat exchanger at least partially disposed within the catalyst bed.

Housing

The reactors of the present invention comprise a housing having an inlet for receiving a process gas and an outlet for directing a product gas out of the housing.

The housing should be of size and shape to suitable to enclose the catalyst bed and the heat exchanger. Preferably, the housing is circular in cross-section having a cylindrical side wall, but it may have other suitable shapes. If desired, the housing can have a removable end plate on one or both ends to facilitate servicing of the reactor. The present reactor may also comprise one or more insulation layers surrounding the housing and/or on its interior wall.

Housings suitable for the reactors of the present invention can be fabricated from any material capable of withstanding the operating conditions described herein and can include, for example, stainless steel, Inconel, Incoloy, Hastelloy, and the like. The reaction pressure is preferable from about 0 to about 100 psig, although higher pressures may be employed. The operating pressure of the reactor depends upon the operating conditions of the fuel processor/reformer and ultimately, the required delivery pressure of the hydrogen-rich reformate. For fuel cells operating in the 1 to 20 kW range an operating pressure of 0 to about 100 psig is generally sufficient.

The housing has an inlet located in a lower portion of the housing for receiving and directing a process gas or reactants into the housing. In the case of a reformer reactor the process gases or reforming reactants include a gaseous fuel and an oxygen-containing gas. The oxygen-containing gas can be in the form of air, enriched air, or substantially pure oxygen. The hydrocarbon fuel is preferably in the gas phase at ambient conditions, but may be liquid provided that it can be easily vaporized. As used herein, the term “hydrocarbon” includes organic compounds having C—H bonds that are capable of producing hydrogen from a partial oxidation or steam reforming reaction. The presence of atoms other than carbon and hydrogen in the molecular structure of the compound is not excluded. Thus, suitable fuels for use in the method and apparatus disclosed herein include (but are not limited to) not only such fuels as natural gas, methane, ethane, propane, butane, naphtha, gasoline diesel and mixtures thereof, as well as alcohols such as methanol, ethanol, propanol, the like and mixtures thereof.

Preferably, the hydrocarbon fuel is natural gas. Furthermore, the preferred hydrocarbon fuel is natural gas at low pressure such as is available in most commercial and residential buildings. Typically, natural gas is provided by a utility provider at pressures as low as about 2 psig. Therefore, the reactors of the present invention must be able to reliably operate on such low pressure process gases. Of course, pressure losses and pressure drops across the reactor(s) become more critical. In particular, neither the reforming reaction nor any of the clear-up reactions, such as high and/or low temperature shift reaction, should impose a substantial pressure drop on the process gas as it passes through the catalyst bed and across the internal heat exchanger. Pressure losses of less than about 3 psig/ft, preferably less than about 2 psig/ft, more preferably less than about 1 psig/ft across the reactor can be acceptable. However, pressure losses of less than about 0.75 psig/ft, preferably less than about 0.5 psig/ft, and more preferably about 0.33 psig/ft should be targeted.

Temperature monitoring may be desired depending on the reaction(s) in a given housing. As such, the reactor housings of the present invention can further comprise at least one sensor for measuring temperature within the reactor. Preferably, two or more sensors will be used to measure temperatures within the housing at different locations, and more specifically, at a plurality of locations within the catalyst bed(s). Preferably, the temperature sensor will be a thermocouple. Thermocouples may be connected to a side wall of the housing at different heights for this purpose. In a preferred embodiment, the temperature sensor will be connected to the top wall of the housing so as to simplify manufacture and assembly. In addition, where two or more sensors are desired, thermocouples having different length probes or adjustable length probes may be connected to the top wall of the housing for measuring temperature at different depths within the housing.

In a preferred embodiment, where the reaction is at least in part controlled based on the temperature of the catalyst bed, the temperature of the catalyst bed is monitored at a plurality of locations and an average temperature is calculated therefrom. It is believed that manipulation of the temperature within the catalyst bed in response to an average of the measured temperatures rather than in response to an individual temperature measurement leads to a more stable temperature profile across the catalyst bed.

Catalyst Bed

A catalyst bed is disposed within the housing in the path of a process gas for contacting the process gas and catalyzing a reaction.

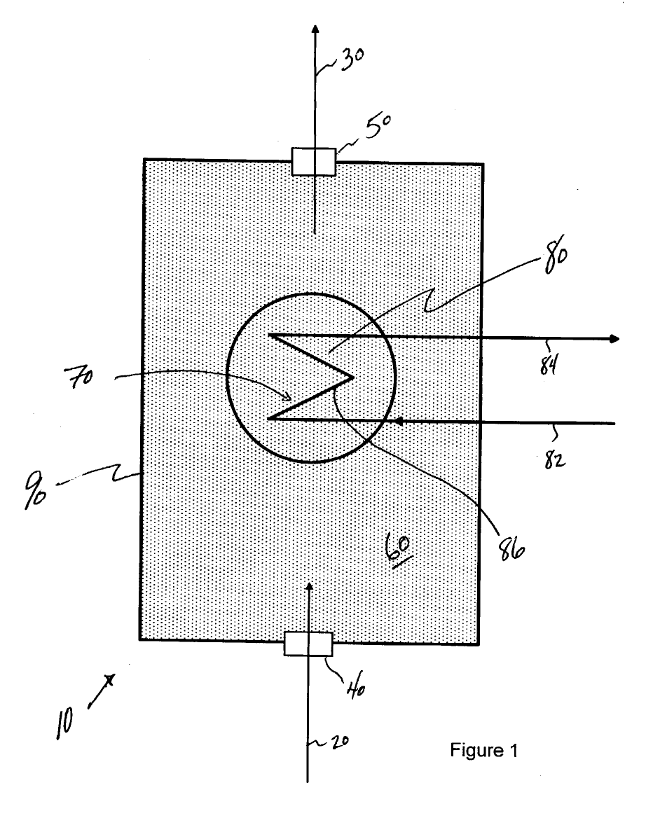

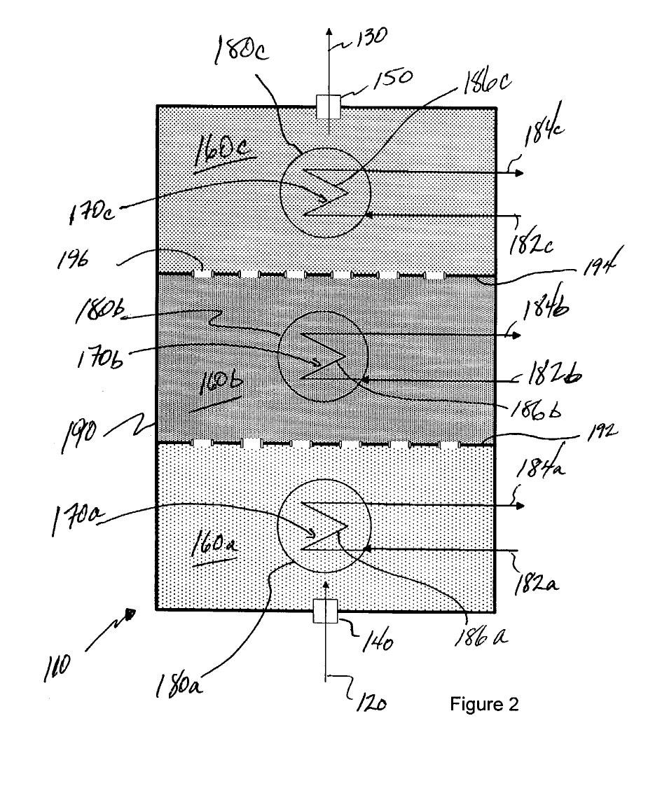

Various reactions and suitable catalyst for use in promoting such reactions are described in detail above and are not repeated here. However, it bears repeating that the reactor of the present invention may comprise a single catalyst bed as illustrated in FIG. 1, or a plurality of catalyst bed as illustrated in FIG. 2.

Where the reactor is used to carry out a reforming reaction, the catalyst bed can comprise a partial oxidation catalyst, a steam reforming catalyst or a mixture of partial oxidation and steam reforming catalysts. Where the reactor is intended to remove sulfur from the process gas, the catalyst bed preferably comprises a pelletized zinc oxide. Where the intended reaction is a shift reaction, a shift catalyst bed comprising a high-temperature, a low-temperature or a mixture of high and low temperature shift catalysts may be employed. The choice of shift catalyst(s) employed in the present reactor will depend on such factors as the temperature and flow rate of the incoming process gas stream(s), the temperature, flow rate, and heat capacity of the heat exchange fluid, and the desired ratio of CO to hydrogen in the process gas exiting the reactor. Where the reactor is intended to perform a number of reactions in two or more catalysts beds arranged in series, similar factors will also affect the choice of additional beds.

As noted herein, the reactors of the present invention can comprise a second bed comprising a catalyst, an inert material, a mixture of catalyst and inert. The catalyst bed and second bed are preferably arranged in series for performing one or more reactions within a common housing. In such an embodiment, perforated plates may be affixed internally to the side walls of the housing to segregate the catalyst beds from one another. However, the use of such plates within the housing may interfere with the flow of process and product gases through the housing and thus, may introduce a higher pressure drop across the reactor. Therefore, where the segregation of catalyst bed is desired, a bed of inert materials should be disposed between the beds. The use of a heat resistant inert material, such as refractory materials that are known in the art, can provide the desired segregation without an accompanying substantial loss in pressure.

Where the reactor preferably comprises a catalyst bed and a second bed and the catalyst bed comprises a partial oxidation and/or steam reforming catalyst, the second bed preferably comprises a pelletized zinc oxide or a shift catalyst, and is more preferably a shift catalyst. Where the reactor preferably comprises a catalyst bed and a second bed and the catalyst bed comprises a high temperature shift catalyst, the second bed preferably comprises a low temperature shift catalyst. Where the reactor preferably comprises a catalyst bed and a second bed and the catalyst bed comprises a desulfurization catalyst, the second bed preferably comprises a low temperature shift catalyst.

Again, the selection of the catalyst will depend on a number of factors such as the type of reformer fuel or the content of the incoming process gas, the temperature and flow rate of the incoming process gas stream(s), the temperature, flow rate, and heat capacity of the heat exchange fluid, and the desired ratio of CO to hydrogen in the process gas exiting the reactor. Persons skilled in the art may readily determine a suitable selection of catalyst(s) for use in the reactors of the present invention for a given fuel processing application.

In addition to catalyst, the catalyst beds used in the reactors of the present invention comprises discrete particles. The discrete particles serve two functions within the catalyst bed. Foremost, the discrete particles provide physical support to the catalyst bed and the catalyst therein. In addition, the presence of discrete particles within the catalyst bed has a diluting effect on the catalyst bed matrix and enables heat generated within the bed to more easily flow to the heat exchanger coils and the process and product gases to pass through the reactor. A second function of the discrete particles is to provide thermal communication or thermal conductivity between the heated catalyst and the heat exchanger. Specifically, the discrete particles are in intimate contact with the catalyst and the outer surface of the heat exchange coil and conduct heat from the catalyst bed to that surface.

The discrete particles are typically catalyst support materials with or without catalyst affixed thereto. Such materials are preferably inert refractory materials that are capable of withstanding high temperatures and that are resistant to thermal shock. Preferred discrete particulate materials include magnesia, alumina, silica, zirconia, or magnesium aluminate, and mixtures thereof. The form of such discrete particles is preferably a flowable particulate or granules. Spherical shapes such as beads are particularly preferred. Discrete particles having a diameter with a size distribution of less than about 0.5 inches, preferably less than about 0.3 inches and more preferably less than about 0.2 inches are preferred for use in the catalyst bed. For optimum heat transfer between the catalyst bed and the heating coils described below without an accompanying significant loss in pressure, it is preferred that the discrete particles comprise an alumina and have a diameter with a size distribution of greater than about 0.05 inches.

Heat Exchanger

Heat exchangers suitable for use in the reactors of the present invention are at least partially disposed within the catalyst bed. The heat exchanging element is preferably coiled tubing or a plate-type heat exchanger as are known in the art. Coiled tubing of various diameters and lengths is preferred where heat exchange within the reactor is desired without a significant loss in pressure on the process gas. Although fins and other structural elements can be added to the tubing to increase the heat exchange surface area, such structures typically disrupt the flow of fluids through and/or over the heat exchanger surface and cause an undesirable drop in pressure. Therefore, it is preferred that the outer surface of the coiled tubing be smooth and continuous, free of appended structures that might otherwise be added to increase the surface area of the tubing.

A stream of a cooling medium is made to flow through the coiled tubing. The choice of cooling medium is not essential to the present reactor, and any suitable heat exchange fluid may be employed, such as air, burner exhaust from associated fuel processing components, water or thermal oil, for example. Where the present reactor is part of a fuel cell electric power generation system, suitable heat exchange fluids further include anode or cathode exhaust streams. Preferably, water is used as the cooling medium because of its availability and cost. Where the cooling medium is water, liquid water within the heat exchanger is typically converted to steam as it passes through the coils. Steam generated as a result of heat transfer may be made available for use elsewhere in a fuel processing system, but is typically enclosed in closed loop with a coolant system as is described in U.S. patent application Ser. No. ______ “Coolant System for Fuel Processor,” Deshpande, et al., filed Apr. 4, 2003 (Attorney Docket No. X-0125), the description of which is incorporated herein by reference.

At least a portion of the discrete particles in the catalyst bed are in intimate contact with the outer surface of the coil tubing and provide thermal communication between the heated catalyst and the coil tubing. A portion of the heat within the catalyst bed is transferred through conduction and convection to the outer surface of the coiled tubing. The heat is then conducted through the tubing wall to the cooling medium within.

In addition, one of the primary objectives of the present invention is a reactor that is compact in size. Therefore, it is preferred that the catalyst bed and the associated heat exchanger also be relatively compact while providing sufficient reactions rates and cooling respectively. In the reactors of the present invention, it is preferred that there be a ratio between the surface area of the heat exchanger and the volume of catalyst bed that is present within the housing. More specifically, the coiled tubing heat exchangers will provide less than about 25 square meters of heat exchanging surface area per cubic meter of catalyst bed volume. Preferably, the coiled tubing heat exchanger provides less than about 20 m²/m³ of catalyst bed volume, more preferably less than about 15 m²/m³ of catalyst bed volume, and still more preferably less than about 10 m²/m³ of catalyst bed volume. In a particularly preferred embodiment, the coiled tubing provides less than 8 m²/m³ of catalyst bed volume. Where the reactor comprises a catalyst bed and a second bed comprising a catalyst within a common housing, both beds need not have the described ratio of heat exchanging surface area to catalyst bed volume. However, in such an embodiment, it is highly preferred that both beds have the described ratio of heat exchanging surface area to catalyst bed volume.

Where greater heat transfer is needed, longer lengths and narrower diameter tubing can be used. In addition, two or more coils may be arranged within a given catalyst bed to achieve the level of heat transfer desired. Given that the reactors of the present invention is intended to be as compact, where two or more cooling coils are to be used within a give catalyst bed it is preferred that those coils be concentrically arranged.

(2) A Method for Cooling a Catalyst Bed in a Reactor

The method comprises the step of contacting a catalyst bed within a reactor with a process gas to catalyze an exothermic reaction to produce heat and a product gas, where the catalyst bed includes discrete particles. The method further includes the step of passing a cooling medium through the catalyst bed within a coiled tubing heat exchanger. In addition, the method includes the step of exchanging heat between the catalyst bed and the coiled tubing during which the discrete particles provide thermal communication between the catalyst bed and coiled tubing.

As noted above, the reactors and methods of the present invention are intended to provide fuel processing methods that impose a minimal pressure drop on the process gases. Pressure drop is in part a function of the path flow the process gas follows through a reactor. Therefore, in the methods and reactors of the present invention, the process gas is at a first pressure and the product gas is at a second pressure and the difference between the first and second pressures is less than about 3 psig/ft, preferably less than about 2 psig/ft, and more preferably less than about 1 psig/ft. In a preferred embodiment, the reactors and methods of the present invention provide a pressure drop of less than about 0.75 psig/ft, more preferably less than about 0.5 psig/ft, and more preferably still, less than about 0.33 psig/ft. Again, it is believed that by providing a ratio of heat exchanger surface area to catalyst bed volume that sufficient cooling of the reaction is achieved while imposing minimal pressure losses on the system. Therefore, the coiled tubing will provide less than about 25 square meters of heat exchanging surface area per cubic meter of catalyst bed volume, preferably less than about 20 m²/m³, more preferably less than about 15 m²/m³, and still more preferably less than about 10 m²/m³ of catalyst bed volume. In a particularly preferred embodiment, the coiled tubing provides less than 8 square meters of heat exchanging surface area per cubic meter of catalyst bed volume.

Preferably, the process gas comprises carbon monoxide and steam. Where the catalyst bed includes a shift catalyst, the inlet temperature of the process gas is above about 130° C. Where the catalyst bed comprises zinc oxide the inlet temperature of the process gas is at a temperature above about 400° C. Where the catalyst bed comprises a partial oxidation catalyst the outlet temperature of the process gas is between about 550° C. and about 900° C. A more detailed description of the individual reactions and process conditions is provided above and in U.S. patent application Publication Nos.: US 2002/0083646 A1 to Deshpande, et al., published Jul. 4, 2002; U.S. 2002/0090326 A1 to Deshpande, published Jul. 11, 2002; U.S. 2002/0090328 A1 to Deshpande, published Jul. 11, 2002; U.S. 2002/0090327 A1 to Deshpande, published Jul. 11, 2002; U.S. 2002/0088740 A1 to Krause, et al., published Jul. 11, 2002; U.S. 2002/0094310 A1, to Krause, et al., published Jul. 18, 2002; U.S. 2002/0155329 A1 to Stevens, published Oct. 24, 2002; U.S. 2003/00211741 A1 to Childress, et al., published Jan. 30, 2003; and U.S. 2003/0021742 to Krause, et al., published Jan. 30, 2003; the disclosures of which are incorporated herein by reference.

(3) A Method for Manufacturing a Shift Reactor

The method comprises the steps of providing a housing having a process gas inlet and a product gas outlet, disposing a heat exchanger within the housing. The heat exchanger includes a length of coiled tubing having an inlet for receiving a stream of cooling medium, an outlet for directing a heated medium from the heat exchanger, and a smooth continuous outer surface. The method further includes obtaining a mixture of a shift catalyst and discrete particles and disposing the mixture within the housing to form a catalyst bed. The coiled tubing provides less than about 25, preferably less than about 20, more preferably less than about 15, and still more preferably less than about 10 square meters of heat exchanging surface area per cubic meter of catalyst bed.

### DETAILED DESCRIPTION OF THE FIGURES

FIG. 1 is a schematic representation of compact fuel processor reactor 10 of the present invention. Reactor 10 includes a cylindrical housing 90, having an inlet 40 for receiving process gas 20 and outlet 50 for directing a product gas 30 out of the housing. Disposed within housing 90 is catalyst bed 60 and heat exchanger 80. Heat exchanger 80 includes conduit 82 for delivering a cooling medium and conduit 84 for directing a heated cooling medium away from the heat exchanger. As schematically shown, heat exchanger includes coiled tubing 86 having a smooth continuous outer surface. In intimate contact with the continuous outer surface of coiled tubing 86 are discrete particles 70 within the catalyst bed. Discrete particles 70 provide thermal communication between the heated catalyst bed and the surface of coiled tubing 86. As illustrated, reactor can serve as a stand alone low temperature shift reactor, or may be interfaced with one or more similar reactors containing a high temperature shift catalyst bed, a desulfurization catalyst bed, and/or a selective oxidation bed.

In another embodiment, the reactor of the present invention may comprise two or more catalyst beds within a common housing. Such an embodiment is schematically illustrated in FIG. 2. Reactor 110 has a common housing 190 and three interconnected beds referenced as 160a, 160b and 160c. Plates 192 and 194 are provided between the different beds. Perforations or openings 196 are provided in plates 192 and 194 to enable the passage of gases. In a more preferred embodiment, plates 192 and 194 will not be present within the housing but each may optionally be replaced with a bed of inert refractory material to separate catalyst beds from one another without imposing structural elements within the housing that might otherwise disrupt the flow of gas and create a pressure drop across the reactor.

A process gas 120 comprising carbon monoxide and water enters the housing through inlet 140. Where the process gas is raw reformate from a reformer, the temperature of the process gas at inlet 140 is typically between about 600° C. and about 900° C. Heat exchanger 180a is disposed within the catalyst bed. Catalyst bed 160a is preferably a desulfurization bed comprising a desulfurization catalyst such as a pelletized zinc oxide. Catalyst bed 160a further comprises discrete alumina particles with or without catalyst. Heat exchanger 180a has inlet conduit 182a, coiled tubing 186a, and outlet conduit 184a for circulating a cooling medium through the bed. Coils 186a have a smooth continuous outer surface that is in intimate contact with discrete particles 170a to promote the transfer of heat from the catalyst bed across the coil surface to the cooling medium. Therefore, within catalyst bed 160a, the process gas is desulfurized and cooled. Upon leaving bed, the desulfurized process gas can have a temperature as low as 300° C.

Alternatively, bed 160a could be an inert bed to cool a process gas, a catalyst bed comprising a partial oxidation and/or steam reforming catalyst for converting a reformer fuel to a hydrogen rich reformate, or a catalyst bed comprising a shift catalyst. The catalyst or inert material used in catalyst bed 160a will depend on the content and conditions of the process gas flowing into the bed.

As illustrated, the cooled desulfurized process gas (not shown) passes into a second bed 160b comprising a low temperature water shift catalyst and discrete particles of alumina 170b. Heat exchanger 180b has inlet conduit 182b, coiled tubing 186b, and outlet conduit 184b for circulating a cooling medium through the bed. Coils 186b have a smooth continuous outer surface that is in intimate contact with discrete particles 170b to promote the transfer of heat from the catalyst bed across the coil surface to the cooling medium. The shift reaction is exothermic increasing the temperature of the bed. The transfer of heat between the bed and heat exchanger 180b maintains the bed temperature between about 130° C. and about 400° C. Again, the catalyst and/or inert materials present in catalyst bed 160b will depend on the content and conditions of the process gas flowing into the bed.

The shifted process gas (not shown) flows into adjacent bed 160c. Bed 160c comprises an inert bed of discrete particles that further cools the shifted reformate before directing the flow of the process gas out of housing 190. Again, the catalyst and/or inert materials present in catalyst bed 160b will depend on the content and conditions of the process gas flowing into the bed.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A compact fuel processing reactor comprising:
a housing having an inlet for receiving a process gas and an outlet for a directing a product gas out of the housing;
a catalyst bed disposed within the housing for contacting the process gas, the catalyst bed comprising discrete particles;
a heat exchanger at least partially disposed within the catalyst bed for cooling the catalyst bed, the heat exchanger comprising coiled tubing and a stream of cooling medium flowing through the coiled tubing; and
wherein the discrete particles are in intimate contact with at least a portion of the coiled tubing and wherein the coiled tubing has less than about 25 square meters of heat exchanging surface area per cubic meter of catalyst bed.

2. The reactor of claim 1, wherein the coiled tubing has less than about 20 square meters of heat exchanging surface area per cubic meter of catalyst bed.

3. The reactor of claim 2, wherein the coiled tubing has less than about 15 square meters of heat exchanging surface area per cubic meter of catalyst bed.

4. The reactor of claim 3, wherein the coiled tubing has less than about 10 square meters of heat exchanging surface area per cubic meter of catalyst bed.

5. The reactor of claim 1, wherein the discrete particles comprise a refractory material.

6. The reactor of claim 5, wherein the refractory material comprises alumina.

7. The reactor of claim 1, wherein the coiled tubing comprises a smooth continuous outer surface in intimate contact with the discrete particles.

8. The reactor of claim 1, wherein the cooling medium comprises water.

9. The reactor of claim 8, wherein the water comprises steam.

10. The reactor of claim 1, wherein the catalyst bed comprises a shift catalyst.

11. The reactor of claim 10, wherein the shift catalyst comprises a low temperature shift catalyst.

12. The reactor of claim 1, wherein the catalyst bed comprises pelletized zinc oxide.

13. The reactor of claim 1, wherein the catalyst bed comprises a partial oxidation and/or steam reforming catalyst.

14. The reactor of claim 1, further comprising at least a second bed comprising a catalyst, an inert or a mixture thereof.

15. The reactor of claim 14, wherein the catalyst bed comprises a high temperature shift catalyst and the second bed comprises a low temperature shift catalyst.

16. The reactor of claim 14, wherein the catalyst bed comprises a desulphurization catalyst and the second bed comprises a low temperature shift catalyst.

17. The reactor of claim 14, wherein the catalyst bed comprises a partial oxidation and/or steam reforming catalyst and the second bed comprises a low temperature shift catalyst.

18. A method for cooling a catalyst bed within a compact reactor, the method comprising the steps of:
contacting a catalyst bed within a reactor with a process gas to catalyze a reaction to produce a product gas, the catalyst bed comprising discrete particles;
passing a cooling medium through the catalyst bed within a coiled tubing heat exchanger; and
exchanging heat between the catalyst bed and the coiled tubing, the discrete particles providing thermal communication between the catalyst bed and coiled tubing;
wherein the process gas is at a first pressure and the product gas is at a second pressure and the difference between the first and second pressures is less than about 3 psi/ft of reactor.

19. The method of claim 18, wherein difference between the first pressure and the second pressure is less than about 2 psi/ft of reactor.

20. The method of claim 19, wherein difference between the first pressure and the second pressure is less than about 1 psi/ft of reactor.

21. The method of claim 20, wherein difference between the first pressure and the second pressure is less than about 0.75 psi/ft of reactor.

22. The method of claim 18, wherein the process gas comprises carbon monoxide and steam.

23. The method of claim 18, wherein the coiled tubing heat exchanger provides less than about 25 square meters of heat exchanging surface area per cubic meter of catalyst bed.

24. The method of claim 23, wherein the coiled tubing heat exchanger provides less than about 20 m²/m³ of catalyst bed.

25. The method of claim 24, wherein the coiled tubing heat exchanger provides less than about 15 m²/m³ of catalyst bed.

26. The method of claim 25, wherein the coiled tubing heat exchanger provides less than about 10 m²/m³ of catalyst bed.

27. The method of claim 18, wherein the catalyst bed comprises a low temperature shift catalyst and an inlet temperature of the process gas is above about 130° C.

28. The method of claim 18, wherein the catalyst bed comprises zinc oxide and the inlet temperature of the process gas is at a temperature above about 400° C.

29. The method of claim 18, wherein the catalyst bed comprises a partial oxidation and/or steam reforming catalyst and an outlet temperature on the process gas is between about 550° C. and about 900° C.

30. A method for manufacturing a compact shift reactor, the method comprising the steps of:
providing a housing having a process gas inlet and a product gas outlet;
disposing a heat exchanger within the housing, the heat exchanger comprising a length of coiled tubing having an inlet for receiving a stream of cooling medium, an outlet for directing a heated medium from the heat exchanger, and a smooth continuous outer surface; and
obtaining a mixture of catalyst and discrete particles and disposing the mixture within the housing to form a catalyst bed;
wherein the coiled tubing provides less than about 25 square meters of heat exchanging surface area per cubic meter of catalyst bed.

31. The method of claim 30, wherein the coiled tubing provides less than about 20 square meters of heat exchanging surface area per cubic meter of catalyst bed.

32. The method of claim 31, wherein the coiled tubing provides less than about 15 square meters of heat exchanging surface area per cubic meter of catalyst bed.

33. The method of claim 32, wherein the coiled tubing provides less than about 10 square meters of heat exchanging surface area per cubic meter of catalyst bed.
